(19) United States
(12) Patent Application Publication
(10) Pub. No.: US 2023/0419755 A1
(43) Pub. Date: Dec. 28, 2023

(54) STORAGE SAFE WITH REMOTE PALM READER

(71) Applicant: Hornady Manufacturing Company, Grand Island, NE (US)

(72) Inventors: Nick Wing On So, Ningbo (CN); Thomas Delattre, Stuart, FL (US); Matthew Mack, Grand Island, NE (US)

(21) Appl. No.: 18/346,400

(22) Filed: Jul. 3, 2023

Related U.S. Application Data
(63) Continuation-in-part of application No. 17/236,119, filed on Apr. 21, 2021, now Pat. No. 11,734,974.
(60) Provisional application No. 63/368,838, filed on Jul. 19, 2022.
(60) Provisional application No. 63/501,740, filed on May 12, 2023.

(51) Int. Cl. G07C 9/00; E05G 1/02; G06V 40/14

(52) U.S. Cl. CPC G07C 9/00563; G07C 9/00912; E05G 1/02; G06V 40/14

(57) ABSTRACT

A safe for the storage of a valuable such as a firearm. The safe has an imaging system that is used to scan a portion of a human in the near infrared spectrum to image blood vessels and determine if the image matches a stored image and thereafter effect unlocking of the safe. A manual override lock system is provided to manually effect unlocking of the safe.

### RELATED APPLICATIONS

This application claims priority as a Continuation-In-Part of U.S. Non-Provisional patent application Ser. No. 17/236,119, entitled “SAFE WITH BIOMETRIC LOCK MECHANISM”, filed Apr. 21, 2021; to U.S. Provisional Patent Application No. 63/368,838, entitled “STORAGE SAFE WITH REMOTE PALM READER”, filed Jul. 19, 2022; and to U.S. Provisional Patent Application No. 63/501,740, entitled “STORAGE SAFE WITH REMOTE PALM READER”, filed May 12, 2023. The contents of the above referenced applications are incorporated herein by reference.

### FIELD OF THE INVENTION

The present invention relates to a device for securely storing handguns and, in particular, to a lightweight storage safe that allows for secure storage, restricted operation, and release of a stored handgun, along with automated movement of a released gun from a stored position to an access position.

### BACKGROUND OF THE INVENTION

Owning firearms for protection is popular for many around the world. Many handgun owners and collectors would like to keep a handgun at a convenient location and ready to use in case of need. However, this would typically have the handgun located where an unauthorized person could access the gun. It also results in a handgun being available for young and/or inexperienced people who might discharge the firearm accidentally.

Handgun safety devices are known, and include such things as trigger locks, cable locks, lock boxes, and the like. While effective for preventing accidental use or misuse, they all preclude the immediate availability of a handgun in a time of need.

Single and multiple gun safes (sometimes called vaults) are known. They are designed for placement on a table or in a drawer in a convenient location. Storage devices are also available for vehicles. They are often constructed in the form of a box with a lid or door. They include a lock device, such as a digital lock or key lock, which provides security to the contents of the safe by preventing the lid or drawer from opening. While effective in limiting access to the contents, they also impede access to the contents if needed in an emergency. They may not store the gun in a consistent position inside. All prior art devices either preclude fast access to the stored gun or do not effectively secure the stored gun. Thus, storage security comes at the expense of fast access.

Another problem with firearm storage devices is that, although a firearm is readily accessible from storage to an owner, it is also readily accessible to small children. The lack of an encasing or safety locks makes for an attractive nuisance to young children. Thus, there exists a need for a way to safely and securely store firearms, and in particular handguns, without the disadvantages described above.

### DESCRIPTION OF THE PRIOR ART

StackOn, GunVault, Sentry Safe and Ivation are brands of handgun safes. Some use digital locks, some use key locks, and some use biometric information for security. All of the known prior art requires the user to physically touch the safe by inputting codes, fingerprint identification, key or the like to cause the safe to open, this system requires the safe to be mounted or stored where the user has suitable access to the safe manually operate the lock mechanism.

Thus, the present safe allows the user to open a safe that is remote from the controller when the controller identifies the user. The present controller is also suitable to operate multiple safes from a single controller. Still yet, the present controller can be moved from proximity of the safe and carried to other locations which may also include safes that can be opened with the same controller.

### SUMMARY OF THE INVENTION

A safe suitable for storing handguns or other valuables is provided. The safe is comprised of an interior compartment which is defined by a plurality of walls, such as a bottom wall, a top wall, and a plurality of sidewalls. One of the walls may be a lockable door or slide assembly. The door or slide assembly may be a sidewall or top wall. The safe assembly is provided with a suitable biometric lock arrangement, particularly, a finger blood vessel or palm blood vessel reader that is suitable for selectively restricting access to the interior of the safe. The finger or palm reader is preferably a remotely mountable pod suitable for reading the finger or palm veins of a user to cause opening of the safe. The remote pod may be connected via wiring, Bluetooth, Zigby chip or other connection suitable to transfer sufficient data to the remotely positioned safe to confirm the identity of the user and send an open signal to the safe for opening of the latch mechanism.

Accordingly, it is an objective of the present invention to provide such a safe that utilizes biometric data, including blood vessels in the fingers or palm of the hand.

It is a further objective of the present invention to provide such a safe with the non-electronic manual means to unlock the safe to provide access to the storage chamber therein.

It is yet another objective of the present invention to provide such a safe with a latch mechanism that allows for re-locking of the safe manually by simply closing the door.

It is a still further objective of the invention to provide such a safe with a digital imaging system that utilizes near infrared light to create a digital image that can be stored in memory in the imaging system.

It is still yet a further objective of the present invention to provide a gun safe that is compact, and which securely stores a handgun in a secure position while allowing easy access to the handgun upon biometric finger or palm recognition data obtained from an authorized user.

Still another objective of the present invention is to provide a safe that uses an electronically operated locking mechanism that selectively secures valuables in a secure position, releasing the access door upon finger or palm blood vessel recognition of the user.

Still yet another objective of the present invention is to provide a palm recognition module that sends the palm data to the safe, wherein the safe includes the software and hardware regarding the recognition data and the decision is made at the safe whether to open or not.

An even further objective of the present invention is to provide a remotely mounted finger or palm recognition module that includes the software and hardware to compare the palm to a database where the decision is made to provide an open signal to the gun safe.

Yet another objective of the present invention is to provide a remote finger or palm vein reader that can be mounted in various orientations for wireless communication to the safe.

Still yet another objective of the present invention is to provide a finger or palm vein reader that can be moved with respect to the safe and carried into sufficiently close proximity to the safe to allow the safe to be opened.

An even further objective of the present invention is to provide a mount for a remote finger or palm reader that can be secured to surfaces with magnetics, adhesives or mechanical means.

Still a further objective of the present invention is to provide a palm or finger blood vessel identification controller that can operate more than one safe.

An even further objective of the present invention is to provide a safe system wherein the remote safe contains a portion of the identifying information of the user so that only the safes that include the proper identifying information are opened.

Still a further objective of the present invention is to provide a palm or finger blood vessel identification controller that can store identifying information of more than one user.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a top front left perspective view of a gun safe utilizing remote palm recognition as a key for opening the gun safe;

FIG. 2 is a partial perspective view of the gun safe secured within a vehicle in an open position presenting the firearm for grasping;

FIG. 3 is a perspective view illustrating the palm reader and palm reader mounting plate;

FIG. 4 is a perspective view illustrating the remote palm reader secured to the dash of a vehicle;

FIG. 5 is a top left perspective view of one embodiment of the vein reader;

FIG. 6 is a top right rear perspective view of the vein reader;

FIG. 7 is a top view of the vein reader;

FIG. 8 is a bottom left front perspective view of the vein reader;

FIG. 9 is a top left front perspective view of the vein reader illustrated secured to the vein reader mount;

FIG. 10 is a top left front perspective view of the vein reader illustrated exploded from the vein reader mount;

FIG. 11 is a front left perspective view of a home safe having the vein reader secured to a front panel of the safe;

FIG. 12 is a top front left perspective view of the vein reader illustrated secured to the vein reader mount and a communication key;

FIG. 13 is a perspective view of the vein reader mount;

FIG. 14 is a top left front perspective view illustrating the vein reader secured to a top surface of a firearm safe with the vein reader mount and the communication key allowing the vein reader to communicate wirelessly with the safe;

FIG. 15 is a partial front perspective view taken along lines 15-15 of FIG. 11 illustrating the vein reader and mount secured to the front door of a safe;

FIG. 16 is a rear perspective view of the vein reader mount illustrated with adhesive backing;

FIG. 17 is a rear perspective view of the vein reader mount illustrated with magnetic backing;

FIG. 18 is a front perspective view of the vein reader mount illustrated with a fastener for securing the vein reader in position;

FIG. 19 is a front perspective view of the vein reader secured to a dash in a vehicle;

FIG. 20 is a front perspective view of the vein reader secured to an air conditioner vent in a vehicle;

FIG. 21 is a top front left perspective view of the vein reader illustrated with a car vent mounting plate;

FIG. 22 is a top front right perspective view of a gun safe utilizing palm recognition as a key for opening the gun safe;

FIG. 23 is a partial side view of the palm reader with a palm in position for reading;

FIG. 24 is a schematic view illustrating the reading of the user's palm; and

FIG. 25 is a perspective view illustrating the gun safe in an open position.

### DETAILED DESCRIPTION OF THE INVENTION

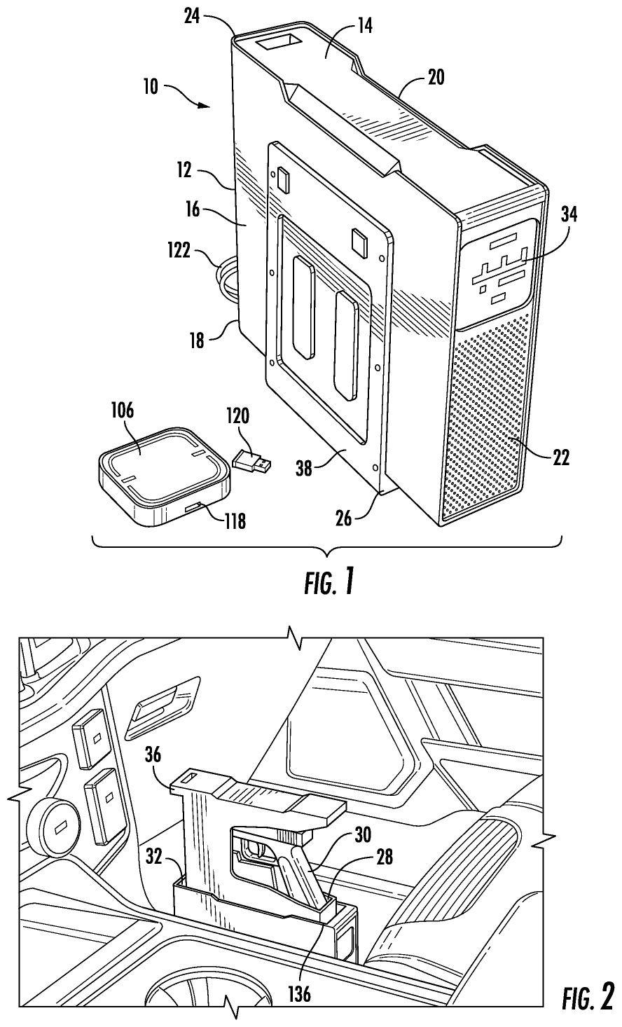

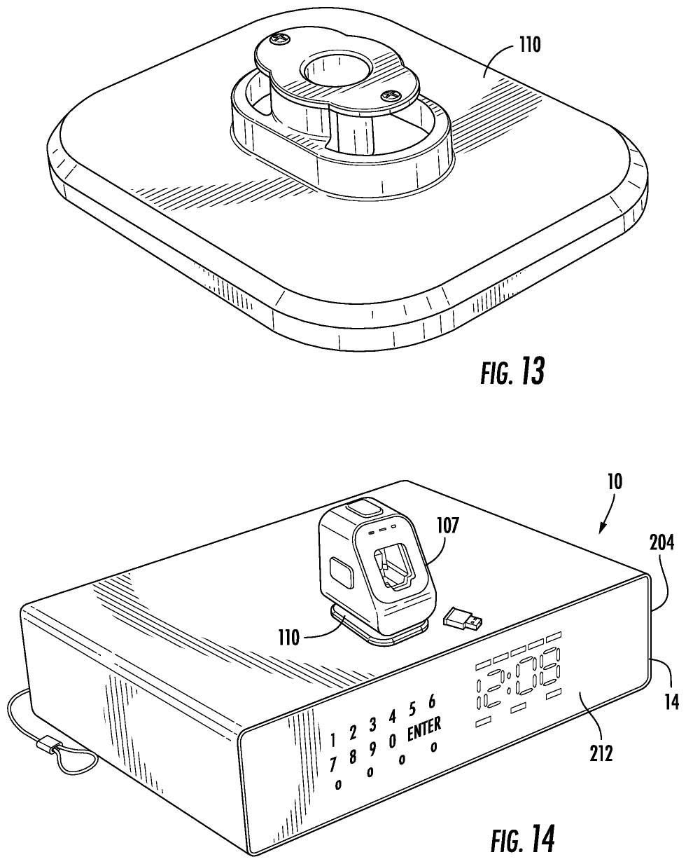

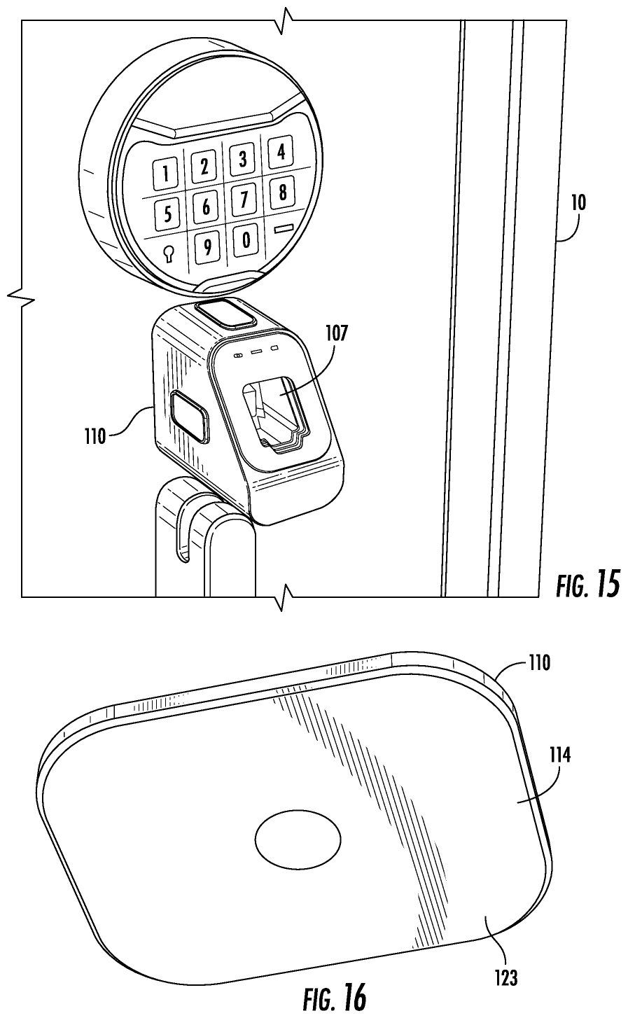

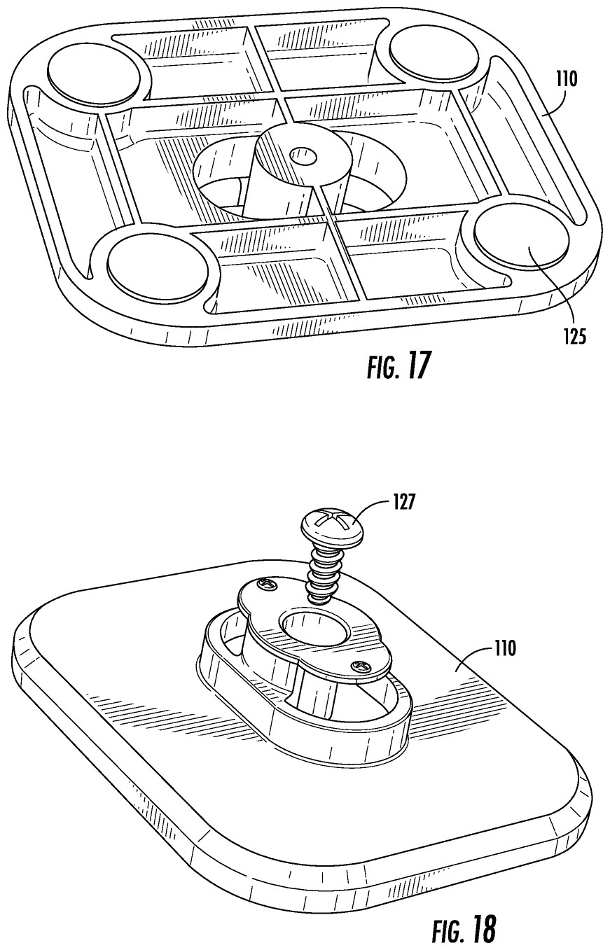

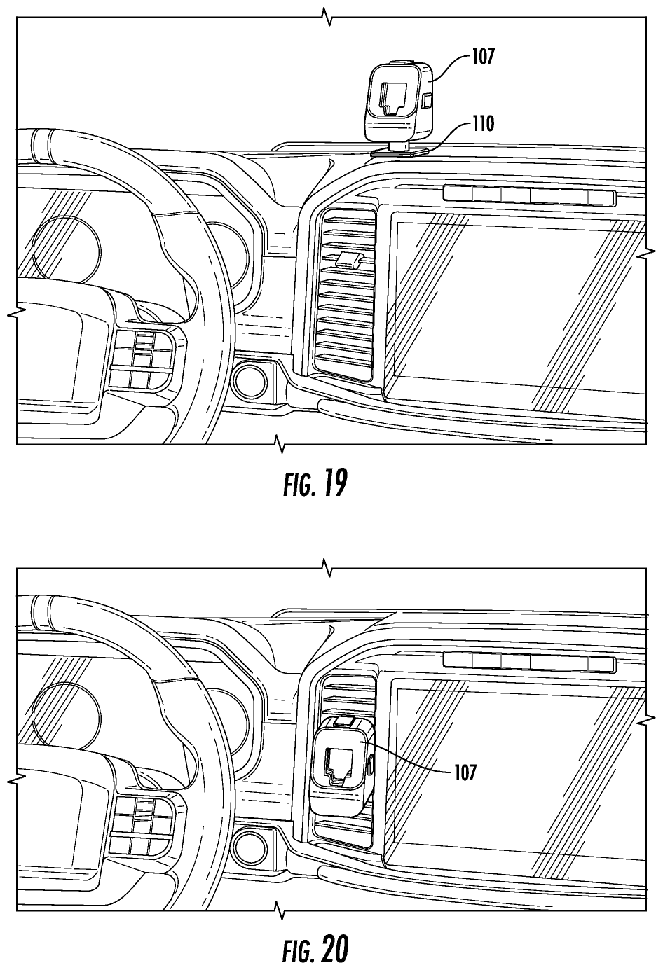

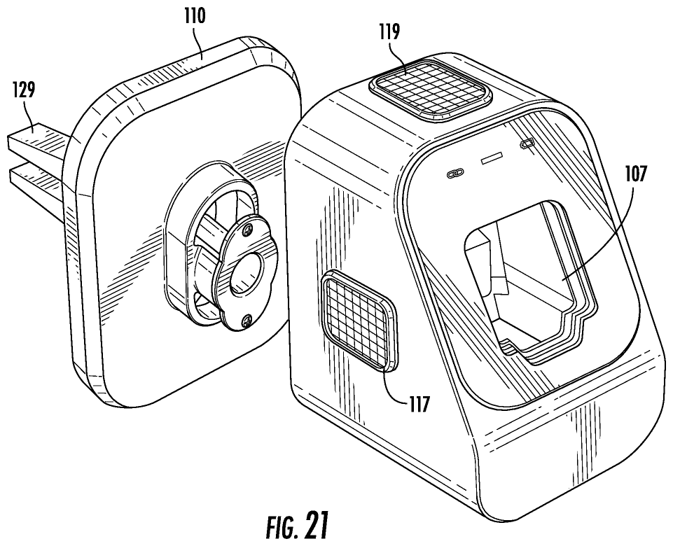

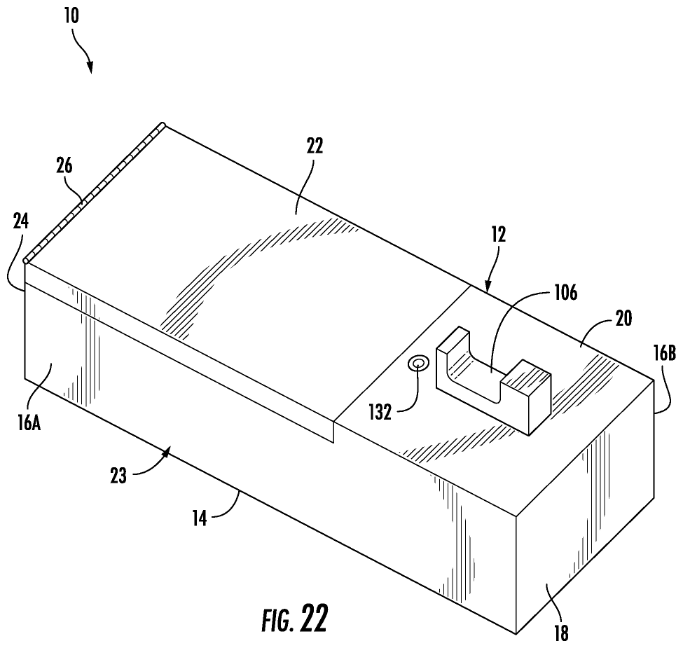

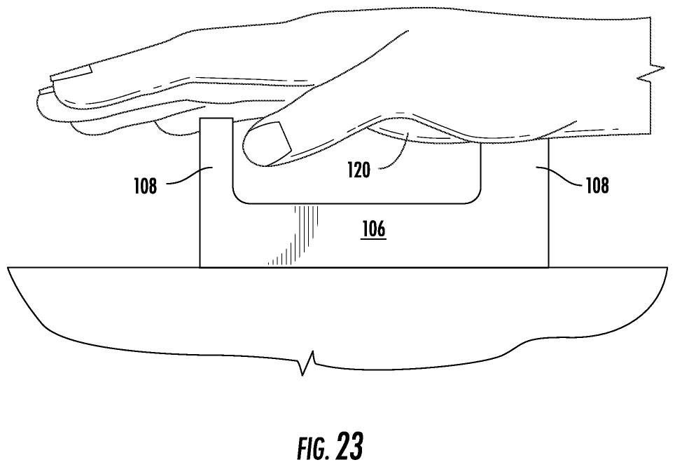

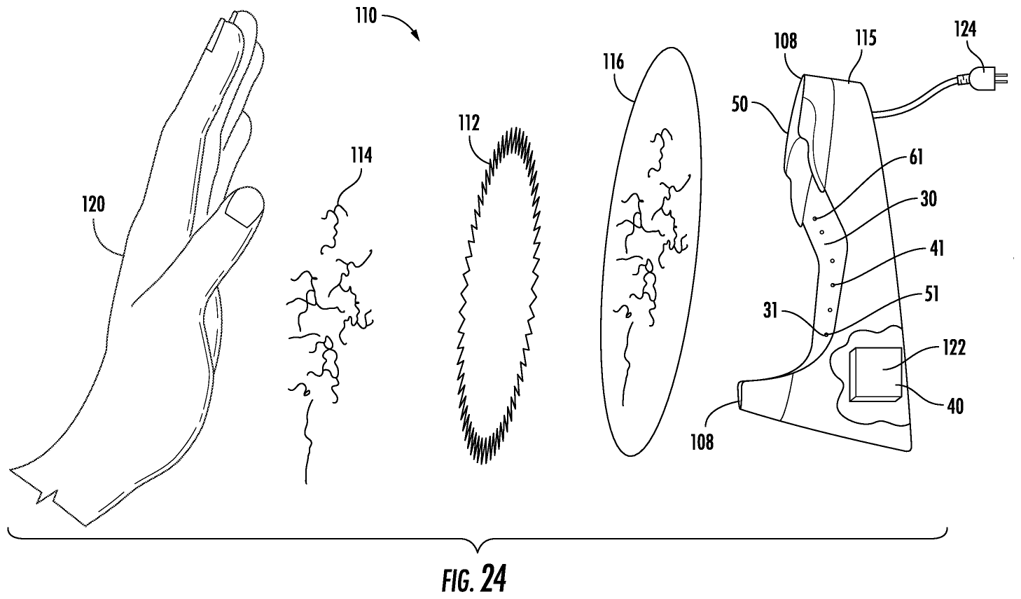

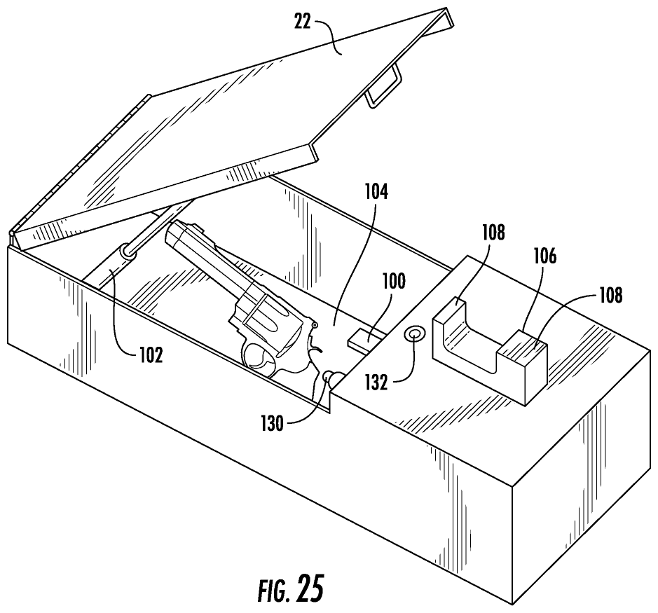

Referring generally to the figures, and more specifically to FIGS. 1-4, 11, and 14-15, a gun safe designated generally 10 is provided. In one embodiment, the safe 10 includes a housing 12 comprised of two halves (half, as used herein, does not mean of equal size but one of two portions), which are illustrated as a base half 16 and the slide 14. As used herein, positional and orientation terms are used in the sense as if the safe 10 were setting on a table or the like with the slide 14 facing upwardly. It is to be understood that the safe 10 can be stored in numerous positions, for example, while being mounted in a vehicle. The safe 10 includes first and second side walls 18, 20, respectively, a front wall 22, a rear wall 24, and a bottom wall 26. In the illustrated structure, the base 16 preferably includes portions of the side walls 18, 20 and portions of the front wall 22 and rear wall 24, leaving the top open for accepting the slide assembly 14. Portions of the slide 14 fit inside portions of the base, side, front and rear walls, to resist penetration of the safe with prying tools. In a most preferred embodiment, the first side, second side and rear walls 18, 20 and 24 are constructed from a single piece of metal connected together along substantially the entire length of the corners to help prevent the insertion of a prying tool between the adjacent edges thereof. The slide 14 and base 16 define a storage chamber 28 that is shaped and configured to hold a valuable, such as a firearm 30, as well as components of a latch mechanism 32 and operational control devices 34 described below. A suitable latch mechanism 32 can be mounted to either the front wall 22 or one of the other walls to selectively maintain the slide 14 in its closed position, while allowing it to be moved to an open position, either manually or automatically. If need be, the slide 14 can be associated with means to effect assisted opening, as for example a spring, gas spring, or the like 36. Other structures may also be provided, such as a safe mounting plate 38 cooperating with the safe 10 to effect mounting in a car or truck, or to a piece of furniture or door in a building. The slide 14 and walls 18, 20, 22, 24 and 26 can be made out of any suitable material, such as a metal alloy and/or polymeric material. Preferably, for a polymeric material, a thermoset material or a high melting temperature thermoplastic is used. FIG. 11 illustrates a safe 10 having welded or formed sidewalls 202, a rear wall 206, a top wall 208, a bottom wall 210, and a door 204, which form an enclosed chamber for storage of valuables, including firearms. In this embodiment, the door 204 is hingedly secured to the sidewalls 202 for movement between an open position and a closed position; wherein the user has access to the goods stored within the safe when the door is in the open position. FIG. 14 illustrates a safe 10. In this embodiment, the safe 10 is constructed to resemble an alarm clock including a clock face 212. This embodiment may include a hinged door 204 or slide 14 without departing from the scope of the invention, and includes secured sidewalls, back wall etc., as described above to prevent unwanted entry into the safe and thus access to the goods stored therein.

Still referring generally to the FIGS., the present gun safe 10 utilizes biometric information to effect opening of a locked safe 10. Palm or finger blood vessel (veins and arteries, herein individually and collectively referred to as vessels for convenience unless otherwise noted) identification is a form of biometric identification technology. Biometric identification using blood vessels provides higher security performance than the traditional identity authentication technique of fingerprinting. Vessels in the finger and palm of the hand can be imaged using near infrared light (preferably a wavelength of approximately 750 nm to about 950 nm) since a hemochrome, such as hemoglobin, absorbs or otherwise resists transmission of near infrared therethrough, while adjacent tissue allows a higher transmission of the light, thereby providing image contrast with other tissue, allowing the vessels to be imaged, compared and identified.

In the identification process, due to palm thickness variations within the hands of various people, reliable imaging can be difficult. Hand movement during imaging can also present problems. Interference with imaging caused by adjacent tissue, such as muscle and bone, can create image noise, making it difficult to image the vessels for comparison and for creating the base image for storage for future comparison.

The present invention improves image quality, and hence accuracy of comparison to authenticate the biometric image as being proper to confirm a match to effect unlocking. The below described system can include a plurality of modules, a palm positioner 106 or a finger positioner 107, a light irradiation intensifier, and an image enhancement device. The palm positioner 106 or finger positioner 107 helps with controlling the finger and palm angles of pitch and skew and rotational deviation angle of the palm or finger. The intensifier can be irradiated by a condenser to help illuminate the palm with improved uniformity of light intensity over the view field. An image enhancement device can utilize a catoptric system to obtain improved marginal information of the palm and finger through a longer light path for improved image contrast.

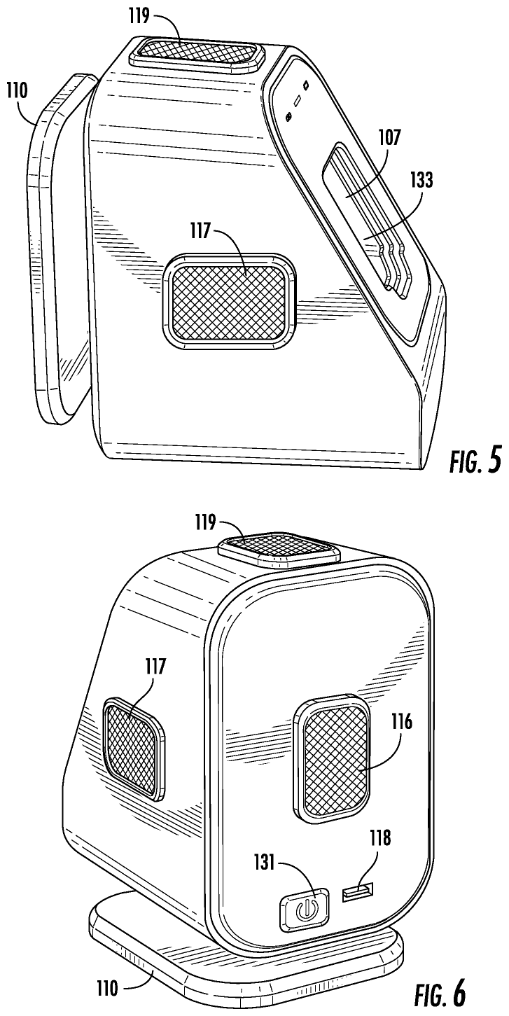

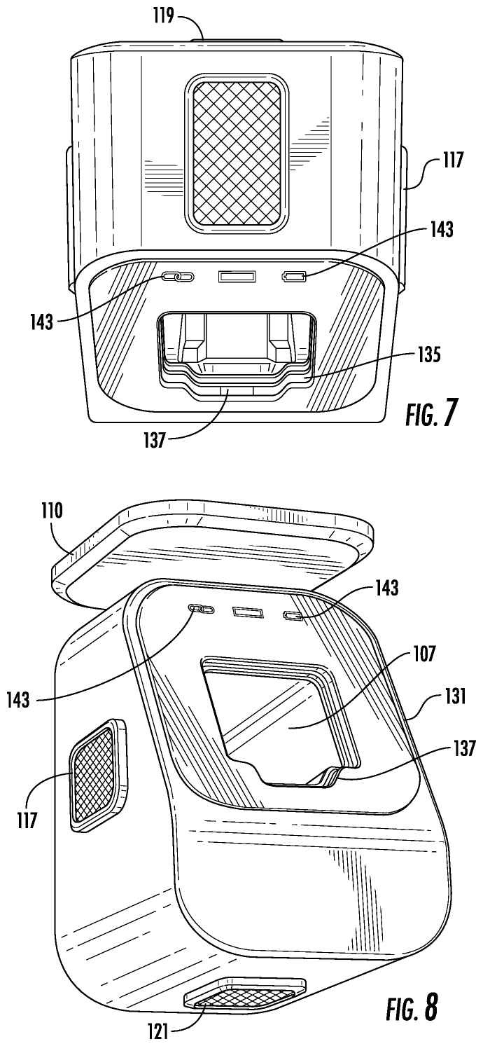

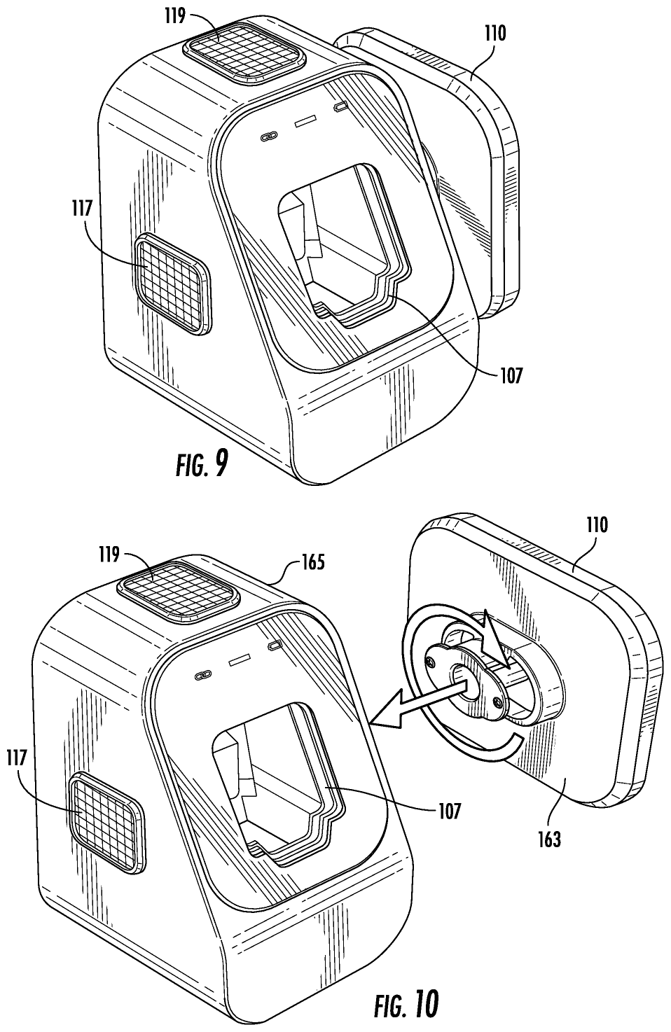

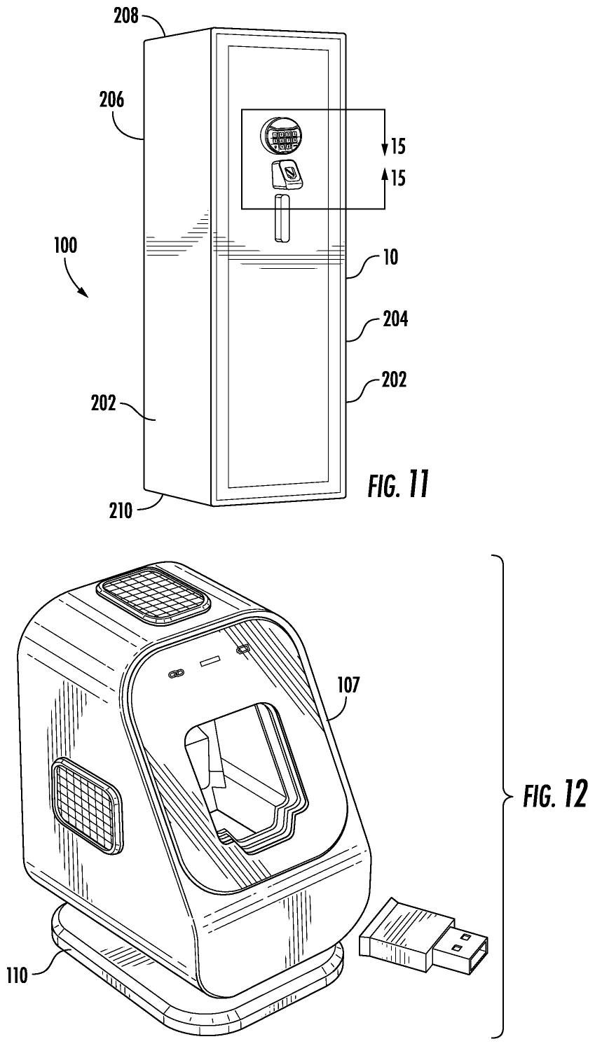

Still referring generally to the FIGS., the biometric identification system for the safe 10 includes a palm positioner 106 or finger positioner 107 which functions as a housing for the biometric identification system. The palm and finger positioner 106, 107 may include a mounting plate 110 which may include palm positioning posts 108 that cooperate with the user's hand to position the palm in a reading position, see FIG. 4. An alternative mounting plate 110 may be constructed as a mounting plate having a first side 112 constructed to interlock with a back surface 116, side surface 117, top surface 119, or bottom surface 121 of the palm positioner 106, 107, while a second side 114 of the mounting plate 110 includes adhesive 123 (FIG. 16), magnets 125 (FIG. 17), a fastener 127 (FIG. 18), or vent fingers 129 or the like, which allows the palm or finger positioner 106, 107 to be attached to most any surface. A twist lock 163 is provided to allow the mounting plate to be interlocked with any of the plurality of sockets 165 provided on the various walls of the palm positioner 106 or finger positioner 107. In this manner, the palm positioner 106 or finger positioner 107 can be positioned in an easily accessible position to read the palm or finger of the user and open a remotely mounted safe to allow the safe contents (e.g. handgun) to be accessed for use. In a most preferred embodiment, the palm positioner 106 or finger positioner 107 is constructed to include a data port 118 that is suitably constructed to cooperate with a dongle 120 or cord 122 for operational control of the latch mechanism 32. When connected to the dongle 120, the palm positioner 106 may be mounted within radio range of the dongle 120, which is constructed and arranged to electrically communicate with the safe 10 for operation thereof. In this manner, the safe 10 can be hidden from view of others and still provide easy access to the user for operation by the user to provide access to the contents of the safe. This is a distinct advantage over prior art devices where the user must provide a finger or a code input directly to the safe for identification, wherein the safe may be positioned, for example, under a vehicle seat. Clearly, inputting a code or providing biometric data to a hidden safe may incur significant delays in accessing the contents of the safe. With the present device, the palm positioner 106 may be positioned at an easily accessible position, such as a vehicle dash panel 124, while the safe is positioned elsewhere in the vehicle. It should be noted that a cord 122 connection to the palm positioner 106 provides the same remote positioning with respect to the palm positioner 106 and the safe; it simply requires a cord 122 to extend between the two devices. It should also be noted that when the cord 122 is utilized to connect the safe 10 and the palm positioner 106, power may be supplied to the palm positioner 106 from the safe 10 and its power supply. Alternatively, a second power port 131 (FIG. 6) may be provided to charge and/or power the palm or finger vein reader. The palm or finger positioner 106, 107 is preferably constructed and arranged to sleep between uses to conserve battery power and, upon human contact being made to the palm or finger positioner 106, 107, the palm or finger positioner 106, 107 switches to an on mode for a predetermined time period, wherein when a palm is positioned across a front face 126 of the palm positioner 106, the palm positioner 106 reads the palm veins in an attempt to identify the user as someone that should be granted access to the contents of the safe 10. The same functions being completed for the finger vein positioner 107.

Still referring generally to the FIGS., a biometric, such as a blood vessel, identification system 100 including alternate features, as discussed below is illustrated. The system 100 is connected to the safe 10 for operation of the lock assembly, and includes an imaging system that is provided with a radiation source module 128, an imaging module 130, a palm positioner 106 or finger positioner 107, and a control module 132 operably associated with one another to provide biometric information for palm or finger control image storage and matching to effect unlocking of the safe 10; whereby a radio or direct signal is sent to the safe to cause the lock of the safe to unlock. The door of the safe may open automatically or it may require the user to move a latch to allow the safe door opening.

The palm positioner 106 includes a pair of palm positioning posts 108 for the receipt of the base of the user's fingers for positioning the palm for imaging, while the finger positioner 107 is provided with an aperture 133 having prongs 135 that position the finger away from the bottom scanning surface 137 to reduce deformation of the finger surface during scanning. The palm positioner 106 and finger positioner 107 are provided with a radiation source positioned for irradiating a palm or finger with near infrared light while positioned on the palm positioning posts 108 or finger prongs 135. A vessel control image is formed as a digital image and stored within internal memory for comparison to an authorized vein image.

The radiation source module 128 includes a light source with an intensity sufficient to pass through a palm placed upon the palm positioning posts 108 or a finger placed on the prongs 135 and be digitally recorded by a camera, described below. Preferably, the light source includes an LED array that emits light toward the palm and the camera directly, or via reflections as described below. The light that impinges on the palm or finger is in the near infrared spectrum, and preferably with a wavelength in the range of between about 750 nm and about 950 nm. Light in this wavelength band is absorbed and/or reflected by the blood in the blood vessels, making the vessels darker in the image than the surrounding tissue, revealing details in shape and structure, such as connections of the vessels adequate for imaging and analyzing them. The wavelength of light can be provided by the LED's light source directly and/or through the use of an optical filter configured for near infrared light transmission.

The palm positioner 106, as well as the finger positioner 107, each includes a switch 134 which will be activated by the presence of the digit in a desired position for initiating the imaging process. The switch 134 is connected to a control module 132 that can include a processor programmed to provide control of the imaging and matching processes, and can include memory, both primary and secondary, for the processing of data and permanent storage of image data for comparison/matching. The switch 134 can be of any suitable type, such as a mechanical microswitch or a proximity switch. Preferably, the switch 134 is a proximity switch, positioned to sense or engage a desired portion of the user's palm or finger. The switch 134 can also be mounted adjacent to the palm positioner 106 or finger positioner 107. The control module 132 is suitably powered, as with a battery and/or line plug such as USB. The palm positioning posts 108 and finger positioning prongs 135 are constructed and arranged to help position and limit movement of the palm and finger in an acceptable orientation of skew, pitch and rotational angular positions. The control module 132 can be provided with a reset function that will allow for the deletion of one or more stored vessel images in order to revoke access to a person and prevent them from opening the safe 10.

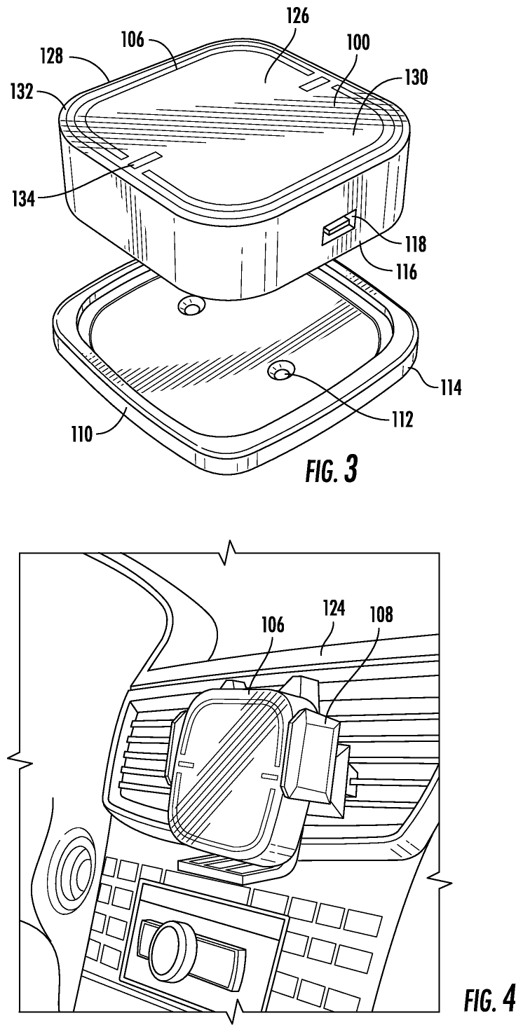

The camera can be any suitable digital camera, as for example, a CMOS camera. The camera is operable to provide image data to the imaging and control modules 130, 132 for processing and possible long term storage to effect future matching and safe unlocking. An imaging function initiator operator, such as a switch 134, is pressed/activated to start operation of the control module 132, the imaging module 130, and the radiation source module 128. It is to be understood that the switch 134 could serve this function. The switch 134 is connected to the control module 132, which is operable to control camera operation and receive image data from the camera. The switch 134 could also be used to select whether the control module 132 is to be used to scan a palm or finger to input a vessel control image for storage and later comparison, or for scanning to determine a match to an authorized user image. A selected mode of operation can be indicated by lights 143 (FIG. 8). Further, for inputting a control image for future image matching, a second switch 136, such as an actuator button inside the safe (FIG. 2), can be provided and access achieved by using a keylock, described below, to open the safe 10 and provide access to the second switch 136 to effect learning of a person's vessel image for image matching. In one embodiment, the imaging module 130 includes at least one light that produces light in the visible spectrum, and is operable to have light therefrom pass through a filter to illuminate the palm or finger, making it visible to the camera. The filter is a photo filter and is operable to filter out near infrared light that has irradiated a palm or finger, but is operable to allow imaging of the irradiated vessels in the palm or finger by the camera.

A reflective light source may be provided and would be operable to provide light to illuminate the surface of a palm, allowing the camera to better record the palm or finger. Light from the reflective light source is preferably in the visible spectrum. The reflective light source directs light toward the palm or finger and preferably includes one or more lights. In this arrangement, the filter would be positioned between the described camera and the user's palm or finger.

In use, a user's palm is placed onto the palm positioning posts 108 or the finger is placed upon the prongs 135 and actuates the switch 134, which in turn powers the lights which illuminate the palm or finger to determine its position, skew, pitch and rotation, and the camera, while providing image data to the control module 132, which will adjust for the palm or finger position through its programming. The lights are then turned off, and the radiation source light is turned on. The radiation source light then provides a vessel image for the camera to start the scanning/matching process. The control module 132 processes the image data from the infrared exposure for feature extraction, and determines if pre-set threshold values are met to determine if there is a match when the system is in matching mode. The control module 132 can then adjust for the position skew, pitch and rotational angles if needed and determine if there is a match to a stored image; and, if there is a match, actuate a locking mechanism described below to unlock the safe 10.

In the comparison to determine match/no match, the control module 132, through its programming, carries out a multimode identification of the images after position normalization conversion. The image analysis and comparison flow includes first carrying out palm or finger elevation information, mean breadth and each regional luminance information; second, effecting noise reduction of the vessel image and carrying out spatial adjustment of the vessel image; third, normalizing the vessel image and adjusting for size difference; fourth, carrying out FFT (fast Fourier transformation) of the vessel image and obtaining characteristic values; and fifth, determining if there is a match or no match. If there is a match, the latching mechanism of the safe 10 is then actuated to unlock the safe 10. This can be carried out via radio signal such as Bluetooth, ZIGBY chip or the like, or may be by hard wire. The finger and palm scanners can store a portion of the data inside of the safe, wherein a hacker or the like gaining access to the circuitry of the palm or finger scanner cannot access the data stored inside of the safe, which may include the data relating to scans of palms and fingers that are allowed entry to the safe. This data can also be utilized as a secondary check, wherein the palm or finger scanner makes an initial determination if the vein scan is acceptable and the scan is rechecked against the data stored inside of the safe 10 before the lock mechanism is unlocked to allow access to the safe. It should also be noted the since the palm or finger positioner can communicate via radio frequency, the identification system 100 can be utilized to open more than one safe, or it can be used by more than one user where each user has access to individual safes where there are multiple safes. In this manner, one user can access one safe while another user can be provided access to a different safe or both safes.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A bio-metric safe assembly comprising:
a housing base comprised of first and second side walls, respectively, a front wall, a rear wall, and a bottom wall, the walls secured together leaving a top portion open and forming a cavity inside of the housing base;
a cover member for covering the top open portion, the cover moveable between a closed position which prevents access to the cavity and an open position which allows access to the cavity,
a latch mechanism constructed and arranged to engage at least one catch member to lock the cover member in the closed position and release the catch member upon receiving an electrical signal from a receiver positioned within the safe, the receiver in wireless communication with a controller,
the controller constructed and arranged to utilize biometric blood vessel information to identify a user, wherein the controller sends a wireless signal to the receiver to operate the latch mechanism when the user is positively identified.

2. The biometric safe assembly of claim 1 wherein the controller includes a palm positioner and palm blood vessels are utilized to identify the user.

3. The biometric safe assembly of claim 1 wherein the controller includes a finger positioner and finger blood vessels are utilized to identify the user.

4. The biometric safe assembly of claim 1 wherein the controller includes a switch activated by the presence of a portion of the user's anatomy in a desired position, the switch initiating an imaging mode for imaging the user's blood vessels and comparison of the images to images stored in a controller memory.

5. The biometric safe assembly of claim 1 wherein the switch is a mechanical switch.

6. The biometric safe assembly of claim 4 wherein the switch is a proximity switch.

7. The biometric safe assembly of claim 4 wherein the controller memory is constructed and arranged to store a plurality of images of user blood vessels used by the controller for comparison to a user's blood vessels.

8. The biometric safe assembly of claim 3 wherein the controller includes a housing, the housing including a finger positioner, the finger positioner constructed to control the rotational deviation angle of the user's finger when inserted.

9. The biometric safe assembly of claim 8 wherein the controller is constructed to include a data port, the data port suitably constructed to cooperate with a dongle for remote operational control of the latch mechanism.

10. The biometric safe assembly of claim 9 wherein the data port is constructed to cooperate with a first end of a cord, a second end of the cord connected to the latch mechanism for direct electrical operation of the latch mechanism from the controller.

11. The biometric safe assembly of claim 2 wherein the controller includes a housing, the housing including a palm positioner, the palm positioner constructed to control the pitch angle and rotational angle of the user's palm when the user's palm is placed upon the palm positioner.

12. The biometric safe assembly of claim 11 wherein the controller is constructed to include a data port, the data port suitably constructed to cooperate with a dongle for remote operational control of the latch mechanism.

13. The biometric safe assembly of claim 12 wherein the data port is constructed to cooperate with a first end of a cord, a second end of the cord connected to the latch mechanism for direct electrical operation of the latch mechanism from the controller.

14. The biometric safe assembly of claim 1 wherein the controller includes a radiation source module, the radiation source module including a light source with an intensity sufficient to pass through the palm or the finger of a user placed on the controller so that an image can be digitally recorded by a camera.

15. The biometric safe assembly of claim 14 wherein the light source is a light emitting diode, the light emitting diode emitting light having a wavelength between 750 nanometers and 950 nanometers.

16. The biometric safe assembly of claim 14 wherein the light source produces light in the visible spectrum, and is operable to have light therefrom pass through an optical filter configured for near infrared light transmission.

17. The biometric safe assembly of claim 14 wherein the controller includes a digital camera operable to provide image data to the control module.

18. The biometric safe assembly of claim 17 wherein the control module adjusts for the position, pitch and rotational angles of the user's finger or palm if needed to determine if there is a match to a stored image.

19. The biometric safe assembly of claim 1 wherein the controller communicates with the latch mechanism via Bluetooth.

20. The biometric safe assembly of claim 1 wherein the controller communicates with the latch mechanism via Zigby chip.

21. The biometric safe assembly of claim 1 wherein at least a portion of the information used to identify the user is stored within the latch mechanism while a portion of the data is stored within the controller, wherein both pieces of data are confirmed before the latch is allowed to open.

22. The biometric safe assembly of claim 21 wherein the controller is operable to open more than one safe, wherein only a safe that confirms the data in the controller and the data in the latch is allowed to open.

23. The biometric safe assembly of claim 1 wherein the cover member is a door.

24. The biometric safe assembly of claim 1 wherein the cover member is a slide.
